(19) United States
(12) Patent Application Publication
(10) Pub. No.: US 2004/0244758 A1
(43) Pub. Date: Dec. 9, 2004

(54) Method for increasing the displacement of an internal combustion engine and engine having increased displacement thereby

(75) Inventors: Weibo Weng, Columbus, IN (US); Gordon L. Starr, Columbus, IN (US)

Correspondence Address: NIXON PEABODY, LLP, 401 9TH STREET, NW, SUITE 900, WASHINGTON, DC, 20004-2128, US

(73) Assignee: Cummins Inc., Columbus, IN

(21) Appl. No.: 10/455,776

(22) Filed: Jun. 6, 2003

(51) Int. Cl. F02F 1/18; B23P 6/02

(52) U.S. Cl. 123/193.4; 123/193.2; 29/888.011

(57) ABSTRACT

A method for increasing displacement of an internal combustion engine having at least one cylinder liner received in a cylinder bore including the steps of removing the cylinder liner from the cylinder bore, and installing a replacement cylinder liner into the cylinder bore. The removed cylinder liner has an internal diameter and an external diameter, and the replacement cylinder liner has an internal diameter and an external diameter, the internal diameter of the replacement cylinder being larger than the internal diameter of the removed cylinder liner, and the external diameters of the removed cylinder liner and the replacement cylinder liner being substantially the same. Preferably, the replacement cylinder liner is made of compacted graphite iron.

### BACKGROUND OF THE INVENTION

1. Field of the Invention

The present invention is directed to a method for increasing displacement of an internal combustion engine, and to engines having increased displacement thereby. In particular, the present invention is directed to increasing displacement of an internal combustion engine by replacing cylinder liners made of conventional iron materials with cylinder liners made of compacted graphite iron and having larger inner diameters.

2. Description of Related Art

In many engine designs, a cast engine block is bored with plurality of cylinder bores sized to receive pistons that reciprocate therein to generate power. Generally, various cooling passages may be integrally cast into the block around the cylinder bores for cooling purposes. In many large displacement diesel engine designs, cylinder liners are used which are inserted into the engine block, the cylinder liners receiving pistons that reciprocate therein to generate power via internal combustion. Such cylinder liners are inserted into the cylinder bores, and in certain applications, form passages upon insertion into the engine block. For example, the cylinder liners may form coolant passages once inserted into the engine block to allow cooling of the internal combustion engine. In addition, such liners may be provided with ports in certain applications, for example, in two stroke engines. These cylinder liners are typically made of iron to reduce wear and to ensure durability while minimizing cost.

Regardless of the engine designs, designing, testing, and manufacturing of an internal combustion engine is a very difficult and expensive task requiring significant capital investment as well as engineering research and development from the engine manufacturers. Not only does the engine manufacturer need to design and test the engine, but it must also invest in the capital equipment required to properly manufacture the engine. This typically involves acquisition of specialized equipment, tools, and dies that are specifically designed to manufacture components of the internal combustion engine.

Depending on the applications of the internal combustion engine, it may later become desirable to increase the displacement of the engine to increase its output such as power and/or torque output. For example, it may be desirable to increase the power and/or torque output of an internal combustion engine so that it can be used in applications for which it was not envisioned at the time the engine was designed and developed.

Costs may be minimized by modifying an existing engine design to provide the desired increase in displacement and corresponding increase in the power and/or torque output. However, increasing the displacement of an internal combustion engine generally requires dimensional modification to the engine block and cylinder head. Such modification would require significant capital and engineering investment into tools and equipment for manufacturing such an engine, although such capital and investment would be significantly less than designing a new engine.

Two different methods are typically employed to increase the engine displacement of an existing engine design. One method is by increasing the bore diameter, and the other method is by increasing the stroke length. Increasing the bore diameter without changing the distance between cylinder centers is a very attractive method for increasing the displacement and output of the engine. However, when an engine has been optimally designed to provide efficient cooling, there is often insufficient material between the coolant passage and the cylinder bore to allow increasing of the bore diameter. Thus, in conventional internal combustion engine designs, durability may be significantly impacted if the bore diameter is increased without changing the distance between cylinder centers. If the distance between the cylinder bore centers is changed, significant changes to the engine block must be made at great expense and essentially requires designing of a new engine.

In internal combustion engine designs that utilize cylinder liners, one method of increasing the bore diameter is by providing extra structural support between the block and the cylinder liner to ensure sufficient material between the cylinder bore and the coolant passages, for example, even when the diameter of the cylinder bores are increased to receive larger cylinder liners. This design has been referred to as a “controlled cooled liner” design. In this design approach, the liner is made using a conventional liner material such as gray cast iron or flake graphite cast iron. However, significant amount of manufacturing processes are required to enlarge the diameter of the cylinder bores to receive the larger cylinder liners. More importantly, many engine designs do not provide for such extra structural support thereby eliminating the applicability of this method.

Various prior art references disclose cylinder liners made of iron that may be used in internal combustion engines. For example, Japanese Patent 60-155665 issued to Ono et al. discloses a cylinder liner having a section made of a flake graphite cast iron which is inserted into a main cylinder liner. The reference also discloses that the surface of the flake graphite cast iron liner is subjected to a hardening process, such as induction hardening. U.S. Pat. No. 6,318,330 to Kestner et al. discloses a dual phase graphite cylinder liner having an outer diameter made of a ductile and vermicular iron, while an inner diameter of the cylinder liner in which the piston reciprocates is made of gray iron. These references do not address the desirability of increasing displacement of engines and are silent as to methods for doing so.

Therefore, there still exists an unfulfilled need for a method of increasing displacement of an internal combustion engine while minimizing costs and capital investment. In particular, there still exists an unfulfilled need for a method of increasing displacement of an engine for increased output without modification to the engine block and cylinder head.

### SUMMARY OF THE INVENTION

In view of the foregoing, an advantage of the present invention is in providing a method for increasing displacement of an internal combustion engine.

Another advantage of the present invention is in providing such a method that minimizes cost and capital investment.

Still another advantage of the present invention is in providing such a method that increases displacement of an engine without modification to the engine block and cylinder head.

These and other advantages are obtained by a method for increasing displacement of an internal combustion engine having at least one cylinder liner received in a cylinder bore in accordance with the present invention. In one embodiment, the method includes the steps of removing the cylinder liner from the cylinder bore, the cylinder liner having an internal diameter and an external diameter, and installing a replacement cylinder liner into the cylinder bore, the replacement cylinder liner having an internal diameter and an external diameter. In accordance with the present invention, the internal diameter of the replacement cylinder is larger than the internal diameter of the removed cylinder liner, and the external diameters of the removed cylinder liner and the replacement cylinder liner are substantially the same. Moreover, in accordance with the present invention, the replacement cylinder liner is made of compacted graphite iron.

In another embodiment, the method further includes the step of hardening an inner surface of the replacement cylinder liner, for example, by induction hardening. In accordance with still another embodiment of the present invention, the piston received in the cylinder liner is an articulating piston, and the method further includes the steps of removing the articulating piston, and installing a single piece replacement piston. In this regard, the single piece piston may be preferably made of forged steel. In yet another embodiment of the present method, the ratio of wall thickness of the replacement cylinder liner thickness relative to diameter of the cylinder bore is less than 6%.

In accordance with another aspect of the present invention, a method for increasing displacement of an internal combustion engine comprises the steps of removing the cylinder liner from the cylinder bore, and installing a replacement cylinder liner made of compacted graphite iron into the cylinder bore, the internal diameter of the replacement cylinder being larger than the internal diameter of the removed cylinder liner, and the thickness of the replacement cylinder liner being smaller than the thickness of the removed cylinder liner.

In accordance with still another embodiment, the method for increasing displacement of an internal combustion engine comprises the steps of removing the cylinder liner from the cylinder bore, and installing a replacement cylinder liner into the cylinder bore, the internal diameter of the replacement cylinder being larger than the internal diameter of the removed cylinder liner, and the thickness of the replacement cylinder liner relative to diameter of the cylinder bore being less than 6% and being smaller than the thickness of the removed cylinder liner.

Preferably, the replacement cylinder liner is made of compacted graphite iron and the method further includes the step of hardening an inner surface of the replacement cylinder liner by induction hardening. In accordance with still another embodiment, the piston received in the cylinder liner is an articulating piston, and the method further includes the steps of removing the articulating piston, and installing a single piece replacement piston that may be made of forged steel.

In accordance with another aspect of the present invention, an internal combustion engine is provided comprising an engine block having a cylinder bore with a bore diameter, and a cylinder liner received in the cylinder bore, the cylinder liner having an internal diameter and a thickness, and being adapted to receive a piston therein, where ratio of the thickness of the cylinder liner relative to diameter of the cylinder bore is less than 6%. In one embodiment, the cylinder liner may be made of compacted graphite iron with an induction hardened interior surface. Preferably, the piston received in the cylinder liner is a single piece piston.

In accordance with still another embodiment, an internal combustion engine is provided comprising an engine block having a cylinder bore with a bore diameter, and a cylinder liner received in the cylinder bore, the cylinder liner having an internal diameter and a thickness, and being adapted to receive a single piece piston therein, where the cylinder liner is made of compacted graphite iron. In one embodiment, the ratio of the thickness of the cylinder liner relative to diameter of the cylinder bore is less than 6%. In addition, the interior surface of the cylinder liner may be induction hardened.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a partial schematic cross-sectional illustration of a portion of an engine block of an internal combustion engine having a cylinder bore and a cylinder liner received therein.

FIG. 2 is a cross-sectional illustration of the cylinder liner of FIG. 1.

FIG. 3 is a cross-sectional illustration of a replacement cylinder liner used in accordance with one aspect of the present invention to increase displacement of the internal combustion engine.

### DETAILED DESCRIPTION OF THE PREFERRED EMBODIMENT

As will be discussed in further detail herein below, the present invention provides a method of increasing displacement of an internal combustion engine for increased output that minimizes costs and capital investment. In addition, as also described in detail below, the method of the present invention allows increasing the displacement of an engine without modification to the engine block and cylinder head. In this regard, the method of the present invention allows the cylinder bore diameter to be increased while maintaining the space claim of the engine. Thus, by practicing the present method of increasing engine displacement, the large capital investment associated with design and manufacturing of a new engine block and cylinder head can be avoided.

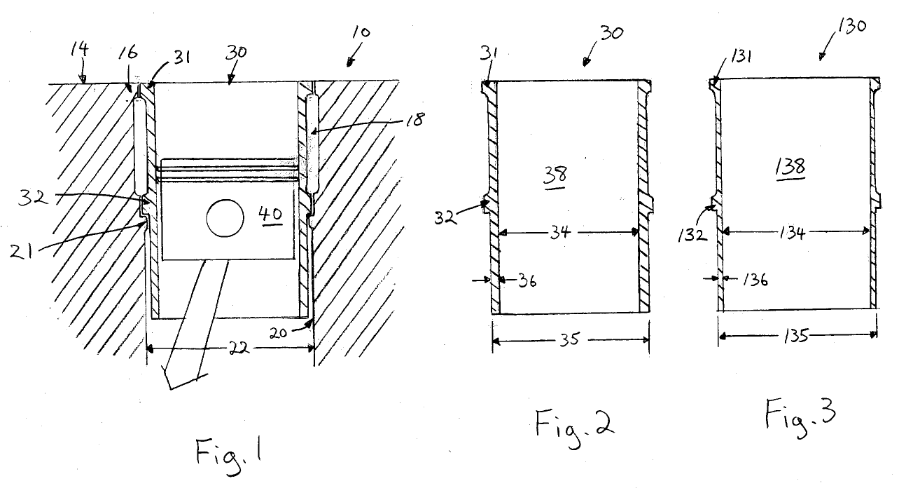

FIG. 1 shows a partial schematic illustration of a portion of an engine block 10 of an internal combustion engine, the engine block 10 having a cylinder bore 20 and a cylinder liner 30 received therein. In the embodiment shown, the cylinder bore 20 is provided with an annular abutment 21. The cylinder liner 30 received within the cylinder bore 20 is provided with a mid-stop 32 that is sized to be supported by the annular abutment 21 of the cylinder bore 20 to thereby support the cylinder liner 30 within the cylinder bore 20.

In addition, in the illustrated embodiment, the top deck 14 of the engine block 10 is provided with extension 16, the top flange 31 of the cylinder liner 30 being sized to be adjacent the extension 16 as shown when the cylinder liner 30 is received within the cylinder bore 20. In the present example embodiment, a gallery 18 is formed between the cylinder bore 20 and the cylinder liner 30. A piston 40 is received in the cylinder liner 30 which reciprocates within the cylinder liner 30 to generate power via combustion of fuel within the cylinder liner 30 in a manner well known in the engine art.

Of course, other components of the internal combustion engine that are not required to appreciate the present invention are not illustrated in FIG. 1. For example, the cylinder head having various valve train, and fuel delivery components are not shown in FIG. 1, but would otherwise be provided in an internal combustion engine. Such components are also well known in the art and thus, are not shown and described herein. In addition, it should be apparent that whereas only one cylinder bore 20 with one cylinder liner 30 and piston 40 received therein is shown in FIG. 1 for clarity purposes, the internal combustion engine may be a multi-cylinder engine so that the engine block 10 may be provided with a plurality of cylinder bores, each having cylinder liners and pistons received therein. Consequently, the portion of engine block shown in FIG. 1 should be understood to be merely illustrative example of an engine block of an internal combustion engine, the displacement of which may be increased in accordance with the method of the present invention described in further detail below.

In the illustration of FIG. 1, the cylinder bore 20 has a bore diameter 22 sized to receive the cylinder liner 30 therein. FIG. 2 shows the cylinder liner 30, the cylinder liner 30 having an interior diameter 34 and an exterior diameter 35, thereby having a thickness 36.

In accordance with the present invention, the displacement of the internal combustion engine is increased by replacing the cylinder liner 30 with a replacement cylinder liner 130 schematically shown in FIG. 3. Like the cylinder liner 30 of FIG. 2, the replacement cylinder liner 130 of FIG. 3 has an interior diameter 134 and an exterior diameter 135, thereby having a thickness 136. Further, the outer diameter 135 of the replacement cylinder liner 130 is substantially the same as the outer diameter 35 of the cylinder liner 30 that is replaced so that the diameter 22 of the cylinder bore 20 can be maintained the same.

In this regard, the cylinder liner 30 is provided with a mid-stop 32 that is sized and positioned to be supported by the annular abutment 21 of the cylinder bore 20 in the manner described above. Furthermore, the top flange 131 is sized so that it is adjacent the extension 16 of the top deck 14 when the cylinder liner 130 is received within the cylinder bore 20. However, in accordance with the method of the present invention, the inner diameter 134 of the replacement cylinder liner 130 is larger than the inner diameter 34 of the cylinder liner 30 that is removed. Consequently, the thickness 136 of the replacement cylinder liner 130 is less than the thickness 36 of the cylinder liner 30 being replaced.

Preferably, the piston 40 is replaced with a replacement piston that is properly sized to be received in the replacement cylinder liner 130 because the inner diameter 134 of the replacement cylinder liner 130 is larger than the inner diameter 34 of the cylinder liner 30 that is replaced. In the above described manner, the displacement of the internal combustion engine is increased thereby allowing increased output such as increased power and/or torque without significant reworking of the engine block 10. In addition, by increasing the displacement of the internal combustion engine through the reduction of thickness of the cylinder liner, the material around the coolant passages are unaffected.

In accordance with the preferred embodiment of the present invention, the replacement cylinder liner 130 is made of Compacted Graphite Iron (hereinafter “CGI”). The replacement cylinder liner 130 made from CGI exhibits better mechanical properties than cylinder liners made of conventional gray cast iron currently used in the industry, and better than cylinder liners made of flake graphite cast iron. The inventors have found that the primary advantage of utilizing CGI for the replacement cylinder liner 130 is that CGI has very similar microstructure as the conventional gray cast iron for tribological and heat transfer purposes. However, CGI has superior mechanical properties when compared to conventional gray cast iron. These superior mechanical properties of CGI over conventional gray cast iron allows the thickness 136 of the replacement cylinder liner 130 to be reduced without altering the exterior diameter 135 of the replacement cylinder liner 135. This correspondingly allows the effective use of the replacement cylinder liner 130 in accordance with the method of the present invention to increase displacement of the internal combustion engine with reduced cost and capital investment.

In the above regard, in one accordance with one embodiment, the ratio of the thickness 136 of the replacement cylinder liner 130 relative to diameter 22 of the cylinder bore 20 is less than 6%. In other words, the replacement cylinder liner 130 may have a thickness 136 which is less than 6% of the diameter 22 of the cylinder bore. In conventional engine designs which utilize cylinder liners, the ratio of cylinder liner thickness to the diameter of the cylinder bore is maintained at a minimum of 6%, or larger, to prevent cavitation erosion, and to provide sufficient mechanical strength. Such reduction in the cylinder liner wall thickness is beyond industrial experience and has not been utilized in industry.

In experimentation, replacement cylinder liners 130 made from CGI demonstrated better mechanical properties in tensile strength and in fatigue when compared to conventional cylinder liners made of gray cast iron. However, two issues with such replacement cylinder liners 130 made of CGI were uncovered. In particular, it was found that wear resistance and scuffing resistance of replacement cylinder liners 130 made of CGI is not as good as conventional liners made of gray cast iron. While such reduced wear and scuffing resistance may be acceptable in certain engine applications, resistance to wear and scuffing is very important especially in heavy duty applications such as in large displacement commercial diesel engines. In such applications, the piston and the piston rings which contact and rub against the inner surface of the replacement cylinder liner 130 can cause significant wear and even scuffing on the inner surface thereby reducing durability of the internal combustion engine. In addition, it has also been found that when the method of the present invention is utilized in certain engine designs, poor cavitation resistance may occur due to a thinner wall thickness of the replacement cylinder liners 130 and the resulting lowered dampening capability.

The above noted issues of increasing displacement utilizing replacement cylinder liners 130 in accordance with the method of the present invention have been resolved by hardening the inner surface 138 of the replacement cylinder liner 130. In this regard, the inner surface 138 of the replacement cylinder liner 130 may be hardened using induction hardening processes which are well known in the art. Such hardening of the inner surface 138 of the replacement cylinder liner 130 has been found to provide sufficient wear resistance and scuffing resistance, even in heavy duty applications such as in commercial diesel engines.

In addition, a single piece replacement piston may be utilized even in those applications where articulating pistons have been typically used, for example, in diesel engine applications. The single piece replacement piston may be made of forged steel to ensure sufficient strength and durability. In this regard, the single piece piston is preferably designed so that the top land or second land which support the rings of the piston do not contact the inner surface 138 of the replacement cylinder liner 130. By utilizing a single piece replacement piston, the kinetic energy from the piston that is transferred to the inner surface 138 of the replacement cylinder liner 130 has been found to be reduced by over 90% by finite element analysis when compared to the kinetic energy transferred by a conventional articulated two-piece pistons which indicates that likelihood of cavitation is greatly reduced.

Experimental test and cavitation test utilizing induction hardened replacement cylinder liners made of CGI in conjunction with one piece pistons made of forged steel confirmed the preliminary findings of the finite element analysis. In particular, replacement cylinder liners made of CGI and having an induction hardened inner surface demonstrated better wear and scuff resistance than cylinder liners made of conventional gray iron, and also exhibited equivalent wear and scuff resistances when compared to conventional gray iron cylinder liners that have induction hardened inner surfaces. In addition, cavitation problems were not observed when utilizing such combination, even with the reduced thicknesses of the replacement cylinder liners.

For example, the displacement of an ISM engine manufactured by the assignee of the present invention was increased using the method of the present invention from 10.82 liters to 11.17 liters for a total displacement increase of 8.2% by increasing the inner diameter of the cylinder liner from 125 mm to 130 mm. This was made possible by utilizing cylinder liners made of CGI that are thinner by 2.5 mm, while maintaining the outer diameter the same so that costs that are typically associated with increasing displacement of an engine is minimized.

In addition, the displacement of an ISX engine also manufactured by the assignee of the present invention was increased using the method of the present invention from 14.95 liters to 16.06 liters for a total displacement increase of 7.4% by increasing the inner diameter of the cylinder liner from 137 mm to 142 mm. This was made possible by utilizing cylinder liners made of CGI that are thinner by 2.5 mm while maintaining the outer diameter the same.

Cavitation and abusive tests of the ISM and ISX engines noted above having increased displacement and utilizing CGI cylinder liners in accordance with the present invention were conducted. After the tests, the replacement cylinder liners made of CGI were inspected. The replacement cylinder liners made of CGI showed no cavitation or scuffing. In addition, wear was found to be acceptable and on par with conventional cylinder liners.

It should now be evident that the present invention provides a method for increasing displacement of an internal combustion engine including the steps of removing the cylinder liner from the cylinder bore, and installing a replacement cylinder liner into the cylinder bore, the replacement cylinder liner having an internal diameter that is larger than the internal diameter of the removed cylinder liner, and the external diameters of the removed cylinder liner and the replacement cylinder liner being substantially the same. It should also be evident that the replacement cylinder liner may be made of CGI that is induction hardened.

In addition, it should also be evident that the present invention also provides an internal combustion engine comprising an engine block having a cylinder bore with a bore diameter, and a cylinder liner received in the cylinder bore, the cylinder liner having an internal diameter and a thickness, where the ratio of the thickness of the cylinder liner relative to diameter of the cylinder bore is less than 6%. Again, it should also be evident that the replacement cylinder liner may be made of compacted graphite iron that is induction hardened.

In view of the above, it should now be evident that present invention provides an effective method for increasing the displacement of an engine without modification to the engine block and cylinder head, thereby avoiding large capital investment associated with design and manufacturing of a new engine block and cylinder head. In addition, it should also be evident that present invention also provides an internal combustion engine in which the ratio of the thickness of the replacement cylinder liner relative to diameter of the cylinder bore is less than 6%. Of course, the present invention may be also readily applied to other types of cylinder liner designs than the mid-stop design shown. For example, the present invention may also be applied to cylinder liners having a top-stop design.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. A method for increasing displacement of an internal combustion engine having at least one cylinder liner received in a cylinder bore, said method comprising the steps of:
removing said at least one cylinder liner from said cylinder bore, said at least one cylinder liner having an internal diameter and an external diameter; and
installing a replacement cylinder liner into said cylinder bore, said replacement cylinder liner having an internal diameter and an external diameter, said internal diameter of said replacement cylinder being larger than said internal diameter of said at least one cylinder liner, and said external diameters of said at least one cylinder liner and said replacement cylinder liner being substantially the same;
wherein said replacement cylinder liner is made of compacted graphite iron.

2. The method of claim 1, further including the step of hardening an inner surface of said replacement cylinder liner.

3. The method of claim 2, wherein said step of hardening said inner surface includes the step of induction hardening said inner surface of said replacement cylinder liner.

4. The method of claim 1, wherein said piston received in said at least one cylinder liner is an articulating piston, and said method further includes the steps of removing said articulating piston, and installing a single piece replacement piston.

5. The method of claim 4, wherein said single piece replacement piston is made of forged steel.

6. The method of claim 1, wherein ratio of wall thickness of said replacement cylinder liner thickness relative to diameter of said cylinder bore is less than 6%.

7. A method for increasing displacement of an internal combustion engine having at least one cylinder liner received in a cylinder bore, said method comprising the steps of:
removing said at least one cylinder liner from said cylinder bore, said at least one cylinder liner having an internal diameter and a thickness; and
installing a replacement cylinder liner into said cylinder bore, said replacement cylinder liner having an internal diameter and a thickness, said internal diameter of said replacement cylinder being larger than said internal diameter of said at least one cylinder liner, and said thickness of said replacement cylinder liner being smaller than said thickness of said at least one cylinder liner;
wherein said replacement cylinder liner is made of compacted graphite iron.

8. A method for increasing displacement of an internal combustion engine having at least one cylinder liner received in a cylinder bore, said method comprising the steps of:
removing said at least one cylinder liner from said cylinder bore, said at least one cylinder liner having an internal diameter and a thickness; and
installing a replacement cylinder liner into said cylinder bore, said replacement cylinder liner having an internal diameter and a thickness, said internal diameter of said replacement cylinder being larger than said internal diameter of said at least one cylinder liner, and said thickness of said at replacement cylinder liner being smaller than said thickness of said at least one cylinder liner;
wherein ratio of said thickness of said replacement cylinder liner relative to diameter of said cylinder bore is less than 6%.

9. The method of claim 8, wherein said replacement cylinder liner is made of compacted graphite iron.

10. The method of claim 8, further including the step of hardening an inner surface of said replacement cylinder liner.

11. The method of claim 10, wherein said step of hardening said inner surface includes the step of induction hardening said inner surface of said replacement cylinder liner.

12. The method of claim 8, wherein said piston received in said at least one cylinder liner is an articulating piston, and said method further includes the steps of removing said articulating piston, and installing a single piece replacement piston.

13. The method of claim 12, wherein said single piece replacement piston is made of forged steel.

14. An internal combustion engine comprising:
an engine block having a cylinder bore with a bore diameter;
a cylinder liner received in said cylinder bore, said cylinder liner having an internal diameter and a thickness, and being adapted to receive a piston therein;
wherein ratio of said thickness of said cylinder liner relative to diameter of said cylinder bore is less than 6%.

15. The internal combustion engine of claim 14, wherein said cylinder liner is made of compacted graphite iron.

16. The internal combustion engine of claim 15, wherein said piston received in said cylinder liner is a single piece piston.

17. The internal combustion engine of claim 15, wherein at least an interior surface of said cylinder liner is hardened.

18. The internal combustion engine of claim 17, wherein said interior surface of said cylinder liner is induction hardened.

19. An internal combustion engine comprising:
an engine block having a cylinder bore with a bore diameter;
a cylinder liner received in said cylinder bore, said cylinder liner having an internal diameter and a thickness, and being adapted to receive a single piece piston therein;
wherein said cylinder liner is made of compacted graphite iron.

20. The internal combustion engine of claim 19, wherein ratio of said thickness of said cylinder liner relative to diameter of said cylinder bore is less than 6%.

21. The internal combustion engine of claim 19, wherein at least an interior surface of said cylinder liner is induction hardened.
